(19) United States
(12) Patent Application Publication
(10) Pub. No.: US 2004/0014485 A1
(43) Pub. Date: Jan. 22, 2004

(54) Foldable and portable telecommunication terminal

(76) Inventors: Toshiaki Sugauchi, Fukuoka (JP); Kazuhito Eto, Fukuoka (JP)

Correspondence Address: RATNERPRESTIA, P O BOX 980, VALLEY FORGE, PA, 19482-0980, US

(21) Appl. No.: 10/412,158

(22) Filed: Apr. 11, 2003

(30) Foreign Application Priority Data
Apr. 12, 2002 (JP) 2002-110158

(51) Int. Cl. H04M 1/00

(52) U.S. Cl. 455/550.1; 455/575.3

(57) ABSTRACT

A foldable and portable telecommunication terminal can change its waiting display extremely with ease. The terminal includes a detector for detecting a change between an open position and a closed position. When the detector detects the change, a controller selects one picture data out of plural picture data stored in a data memory and displays the selected one on a display section.

### FIELD OF THE INVENTION

The present invention relates to a foldable and portable telecommunication terminal that can display picture data stored in a memory on a display section.

### BACKGROUND OF THE INVENTION

Some of foldable and portable telecommunication terminals such as cellular phones have been recently equipped with a function, with which a user can change a waiting display in a standby mode. For instance, Japanese Patented Publication No. H07-114512 discloses a selectable retrieving receiver, which stores some text data in a memory circuit, and displays the text data during a waiting display period. Japanese Patent Application Non-examined Publication No. H10-41847 discloses an apparatus, in which a user can enter a single or plural display contents in a memory and select one to display during a waiting display period. As such, a user programmable display to be used during a waiting display period can characterize the terminal proper to that user and not to any others. In order to satisfy a user's taste, the user can change the display of the terminal. Such terminals have been developed. However, the foregoing conventional structure needs cumbersome key-operations to change a waiting display.

### SUMMARY OF THE INVENTION

The present invention addresses the problem discussed above, and aims to provide a foldable and portable telecommunication terminal in which a user can change a waiting display extremely with ease.

The foldable and portable telecommunication terminal of the present invention comprises the following elements:

a memory that can store plural picture data; and

open/close detecting means for detecting a change from a folded status to an opening status or an action of closing the terminal from an open posture to the folded status.

When the detecting means detects a change from the folded status to the opening status, a user can select one of the plural picture data stored in the memory for displaying it.

### BRIEF DESCRIPTION OF THE DRAWINGS

FIG. 1 shows a structure of a foldable and portable telecommunication terminal in accordance with an exemplary embodiment of the present invention.

FIG. 2 shows an appearance of a foldable and portable telecommunication terminal in accordance with an exemplary embodiment of the present invention.

FIGS. 3A, 3B, 3C, 3D show display contents in a waiting display mode of a foldable and portable telecommunication terminal in accordance with an exemplary embodiment of the present invention.

FIG. 4 shows contents of a memory that stores waiting display information in accordance with an exemplary embodiment of the present invention.

FIG. 5 shows a flowchart illustrating a process of changing a waiting display of a foldable and portable telecommunication terminal in accordance with an exemplary embodiment of the present invention.

FIGS. 6A, 6B show contents displayed on a waiting display of a foldable and portable telecommunication terminal in accordance with an exemplary embodiment of the present invention.

### DETAILED DESCRIPTION OF THE EXEMPLARY EMBODIMENT

An exemplary embodiment of the present invention is demonstrated hereinafter with reference to the accompanying drawings.

Exemplary Embodiment 1

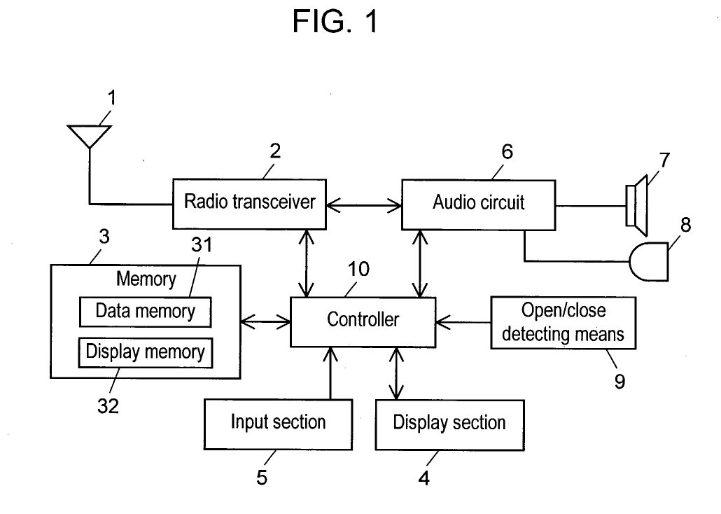

FIG. 1 shows a structure of a foldable and portable telecommunication terminal in accordance with the first exemplary embodiment of the present invention. In FIG. 1, the foldable and portable telecommunication terminal comprises the following elements:

antenna 1 for communicating with a base station (not shown);

radio transceiver 2 for transmitting/receiving radio signals to/from the base station via antenna 1;

memory 3 for storing: (a) picture data obtained via e-mail or a camera (not shown), (b) a telephone directory used by a user as needed, and (c) an operating program for the entire terminal;

display section 4 for displaying: (a) picture data selected from the memory during a standby mode, (b) a phone caller's data (phone number, name of the caller) when a call arrives, or (c) a screen guiding a user to enter a desirable function;

input section 5 for entering various functions or phone numbers;

audio circuit 6 including codec IC (conversion of PCM digital signal to/from analog signal) for voice communication between a user and a counterpart on the other end via the base station (not shown);

speaker 7 for outputting ringer tones such as a ringing melody or a warning sound those are entered by a user;

microphone 8 for transmitting a user's voice to the counterpart on the other end;

open/close detecting means 9 for detecting a movement between an open position and a closed position of the terminal;

controller 10 for controlling the entire terminal.

In this first embodiment, memory 3 is formed of a semiconductor memory and equipped with data memory (first memory) 31 and display memory (second memory) 32 for storing information of a waiting display. Data memory 31 and display memory 32 can be assigned respectively to two independent semiconductor memories. If data memory 31 needs a large capacity, it can be formed of an optical disk or a hard disk.

Open/close detecting means 9 detects both of the cases, i.e., when the terminal is folded (movement from the open position to the closed position), and when the terminal is opened (movement from the closed position to the open position.)

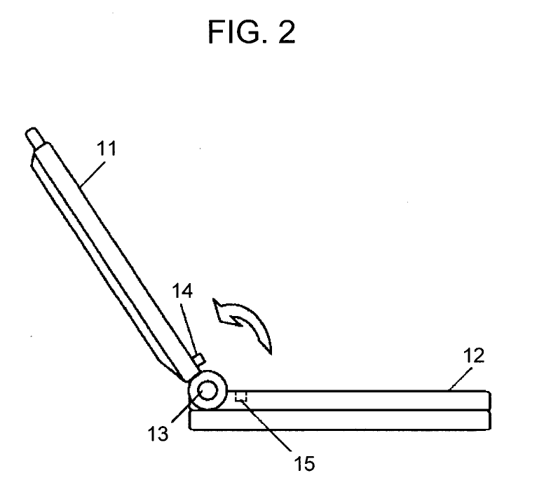

FIG. 2 shows an appearance of the terminal in accordance with the first exemplary embodiment of the present invention. First housing 11 includes antenna 1 and display section 4 (not shown in FIG. 2), and second housing 12 includes radio transceiver 2, memory 3, input section 5, and audio circuit 6 (not shown in FIG. 2). Hinge 13 couples first housing 11 to second housing 12 at the end of both the housings such that respective housings can rotate on hinge 13. Hinge 13 allows a user to fold the terminal so that it can be put into a pocket, or to open first housing 11 and second housing 12 so that a user can place a phone call using the terminal. In the open position, projection 14 is physically away from switch 15, so that switch 15 is not depressed. Open/close detecting means 9 detects whether switch 15 is depressed or not depressed.

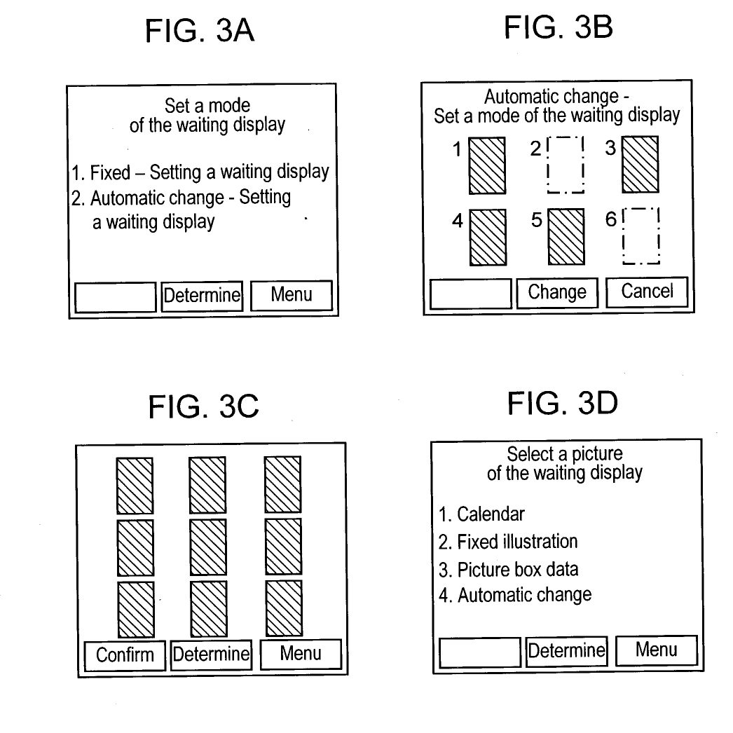

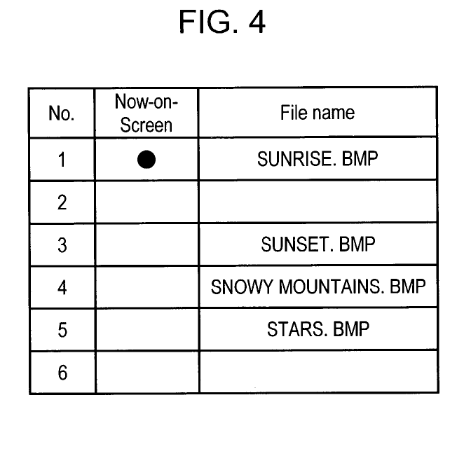

FIGS. 3A-3D show display contents in a waiting-display mode of the terminal in accordance with the first exemplary embodiment of the present invention. FIG. 3A shows the display contents of the waiting-display (or screensaver) setting mode. FIG. 3B shows the display contents of changing automatically the waiting display. FIG. 3C shows selectable picture-data for changing automatically the waiting display. FIG. 3D shows the contents for setting a mode of the waiting display. FIG. 4 shows contents of a memory that stores waiting display information in accordance with the first exemplary embodiment of the present invention.

Setting the waiting display of the terminal discussed above is demonstrated hereinafter. First, operate input section 5 to display the waiting-display setting mode on display section 4 (FIG. 3A). In this status, when a user wants to display a picture selected by the user as a waiting display, the user selects “1. Fixed—Setting a waiting display”, then a list of picture data (not shown) with given extensions such as BMP, JPG stored in data memory 31 is displayed on display section 4. The user selects favorable one out of the list through input section 5. This selection allows the user to display the picture data stored in the memory always as the waiting display. The picture data stored include picture data received via e-mail and taken by a camera.

Instead of displaying always the same picture data, if a user wants to display the waiting display with plural picture data changing automatically, the user selects “2. Automatic change—Setting a waiting display” by operating input section 5. Selection of “2. Automatic change” prompts controller 10 to display the screen shown in FIG. 3B on display section 4. As FIG. 3B shows, boxes 1, 3, 4 and 5 are hatched, and picture data stored correspond to those numbers. This setting is stored in display memory 32, and as shown in FIG. 4, file-names are stored corresponding to the numbers. To be more specific, No. 1=“SUNRISE. BMP”, No. 3=“SUNSET. BMP”, No. 4=“SNOWY MOUNTAINS. BMP”, No. 5=“STARS. BMP”. Those file names indicate the file names of the picture data stored in data memory 31. To identify which file is active, namely, now on screen, the file is marked with, e.g., a black circle as shown in FIG. 4. A user can recognize that no vide data are available in No. 2 and No. 6.

When a user selects “2. Automatic change” for the first time, no picture data are available from No. 1 to No. 6 at all, and the user selects some out of the picture data stored in data memory 31 by operating input section 5 and enters them corresponding to No. 1 through No. 6. The procedure is described specifically hereinafter. In the status shown in FIG. 3B, select the number which the user wants to enter or change by operating input section 5, then the screen shown in FIG. 3C is displayed. At this time, all the picture data stored in data memory 31, namely, THUMBNAIL is displayed. The user selects a favorable one out of them by operating input section 5. The foregoing procedure is used for setting which picture data is displayed in each waiting mode, and the user should eventually select which waiting mode is to be used. A specific operational procedure is demonstrated below:

The screen for selecting a waiting display, which is shown in FIG. 3D, is displayed on display section 4, and if a user wants to display a calendar as a waiting display, the user selects “1. Calendar” by operating input section 5. If the user wants to display a fixed illustration initially prepared in the terminal, the user selects “2. Fixed illustration”. If the user wants to display a certain picture data selected out of the picture data stored in data memory 31, the user selects “3. Picture box data”. The picture data stored in data memory 31 includes picture data attached to an e-mail received by the user, picture data downloaded from a center or a server of a radio communication network, or picture data shot with a camera (not shown) come with the terminal as an accessory. If the user wants to display plural picture data selected from those stored in data memory 31, the user selects “4. Automatic change” by operating input section 5.

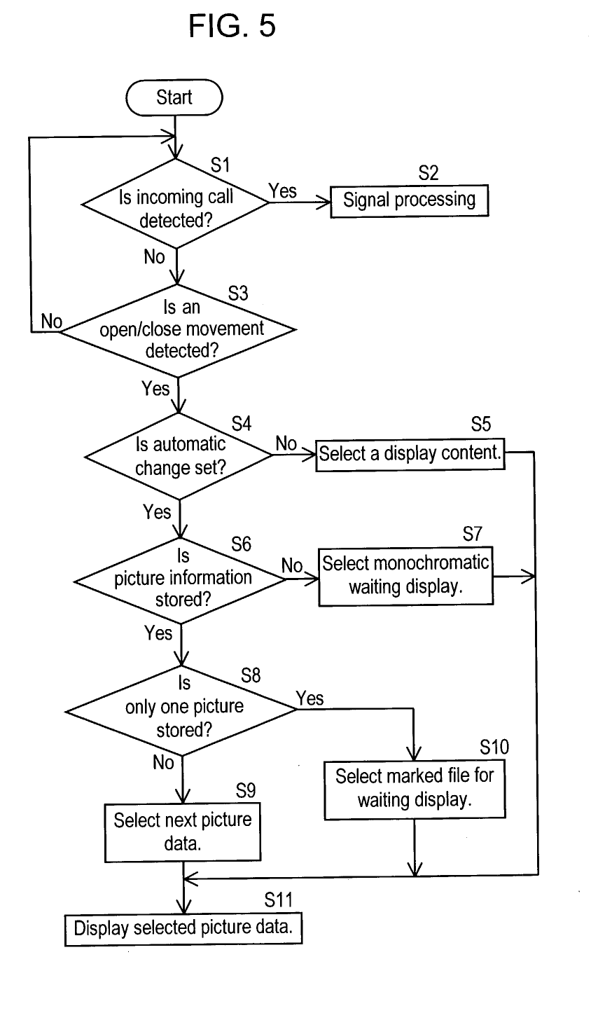

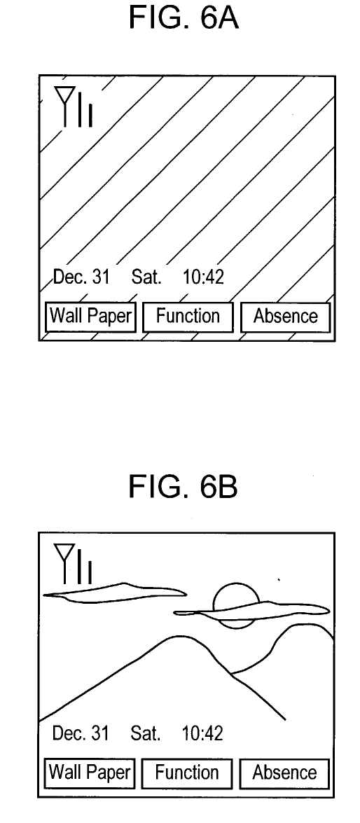

Next, a display operation of the terminal, in which the waiting display discussed above is programmable, is demonstrated specifically with reference to FIGS. 5, 6A and 6B.

First, in a closed position of the terminal, when an incoming call is detected (S1), the signal is processed ordinarily (S2). The ordinal process is to output ringer tones from speaker 7 and display a name and a phone number of a caller on display section 4.

If no incoming call is detected and a movement from the closed position to the open position of the terminal is detected (S3), controller 10 determines whether or not the operation mode of the waiting display is set at “Automatic change” (S4). When “Automatic change” is not set, select a display content corresponding to the operation mode set in advance (S5). The operation mode already set has been selected out of“1. Calendar”, “2. Fixed illustration”, and “3. Picture box”.

When the Calendar is assigned to the operation mode, the information of Calendar is retrieved from data memory 31 to be displayed on display section 4. If the “Fixed illustration” is assigned to the operation mode, the picture data of “Fixed illustration” is retrieved from data memory 31 before it is displayed on display section 4. When the Picture box is assigned to the operation mode, the user retrieves the selected picture data out of those stored in data memory 31 and displays it on display section 4.

On the other hand, when the waiting display is set at “Automatic change”, controller 10 further determines whether or not display memory 32 stores the picture information (S6). In other words, if the table shown in FIG. 4 stores none of the file names, display memory 32 stores no picture information.

No picture information stored in display memory 32 prompts to display a given monochromatic waiting display with no patterns based on the assumption that no picture data is available in data memory 31 (S7). The given monochromatic display can be selected in advance by the user from plural colors such as red, blue, green and white through input section 5. To be mores specific, as shown in FIG. 6A, the waiting display is monochromatic screen with no patterns, and symbols illustrating a status of radio-wave from the base station (not shown), present date and time, and guides to key-operation are displayed on this screen. Such a monochromatic and patternless waiting display is used as a background.

When picture information is stored in display memory 32, controller 10 determines whether only a single piece of picture information or plural pieces of picture information are stored in memory 32 (S8). In other words, controller 10 determines whether the table shown in FIG. 4 stores one file name or plural file names.

In the case of a single piece of picture information stored in memory 32, the picture data information, displayed on the waiting display before the terminal has been folded, namely, the file-name marked as “now on screen”, is retrieved from display memory 32 (S10). Then the picture data corresponding to the file name retrieved is taken out from data memory 31 to be displayed on display section 4. In this case, the information of the picture data displayed before the terminal has been folded remains unchanged (S11).

On the other hand, when plural pieces of picture information are stored in display memory 32, the number assigned to the picture data displayed before the terminal has been folded is retrieved from display memory 32. The number is marked as “now on screen” out of 1-6 listed in the table shown in FIG. 4. Then a file name corresponding to the number next to the retrieved number is taken out from display memory 32, and the picture data corresponding to the file name is retrieved from data memory 31, and the picture data is selected to be displayed on display section 4 (S9). The selected picture data is displayed on display section 4 (S11). For instance, the picture data assigned No. 1 is retrieved, and then the waiting display shows the picture data of “SUNRISE. BMP” as shown in FIG. 6B, and on this screen, symbols illustrating a status of radio-wave from the base station (not shown), present date and time, and guides to key-operation are displayed. As such, the picture data of “SUNRISE. BMP” is used as a background.

As discussed above, when “Automatic change” is assigned to the operation mode, the waiting display can be sequentially changed following the numbers that are stored in display memory 32 and correspond to the file names. This can be done every time a user opens the terminal in the standby mode. The waiting display can be changed within the bounds of the picture data corresponding to the plural file names stored in display memory 32. When a user assigns the “Automatic change” to the operation mode of the waiting display, the display works properly even if no picture data or only one picture data is selected in display memory 32. In stead of changing the display sequentially within the bounds of the picture data corresponding to the plural file-names stored in display memory 32, the display can be changed at random. In this case, the display can be changed regardless of the sequence set by the user, and this random change can be to the user's taste.

An incoming call at the closed position of the terminal (S1, S2) prompts the ordinary receiving process, so that the active mark indicating “now on screen” in display memory 32 is not moved. Therefore, after the call is received and finished, the same picture data as displayed on the waiting display before the terminal was folded appears on display section 4. This is because of the following situation: If the active mark in display memory 32 is set to move at the receiving process after a detection of an incoming call, the procedure of S3 and onward is needed at the receiving process. This makes the program complicated. Therefore, the procedure of S3 and onward is executed only in the waiting status, so that the program is kept from being complicated, and the operation of the present invention can work simply and with ease.

In general, an incoming call prompts an incoming display, and after the user finishes the call, it is not so often that the user still operates the terminal. On the other hand, the user sees the waiting display whenever the user is going to place a phone call, so that it seems less necessary to carry out the procedure of S3 and onward when the user opens the folded terminal that is receiving an incoming call. However, the waiting display can be changed when the user opens the folded terminal that is receiving an incoming call.

Many of the foldable and portable telecommunication terminals are equipped with such a mechanism that the display section is turned on or off by a detection result of opening/closing the housing. However, according to the present invention, the display section can be turned on or off simply by modification of the software.

In this exemplary embodiment, a detection of a change from the closed position to the open position of the terminal prompts the waiting display to change the picture data sequentially or at random within the bounds of the picture data corresponding to the file-names stored in display memory 32. On the other hand, a detection of a change from the open position to the closed position of the terminal naturally can change the waiting display sequentially or at random within the bounds of the picture data corresponding to the file-names stored in display memory 32. In this case, the detection of the change from the open position to the closed position allows selecting a picture to be displayed on the display section. Therefore, a picture can be changed even if a user opens the folded terminal that is receiving an incoming call, so that it is avoided that the program becomes complicated due to the execution of procedure of S3 and onward during the receiving process. This proves that the present invention is extremely effective. In addition to the change of the waiting display, changes of a ringer tone and an LED color that notifies a user of an incoming call would further satisfy users' taste with a wide range of variations.

In this embodiment, first housing 11 includes only one display section 4; however the present invention can be applied to a terminal that has plural display sections such that the front face of housing 11 is equipped with a first display section and the rear face of housing 11 is equipped with a second display section.

In this case, a detection of a change from the open position to the closed position can select a picture to be displayed on the first display section, and a detection of a change from the closed position to the open position can select a picture to be displayed on the second display section.

Memory 3 can include a second display-memory for the second display section.

In this embodiment, the foregoing description refers to the terminal split into two parts, i.e., the first and second housings. However, the present invention is applicable not only to the embodiment discussed above, but also to a foldable and portable telecommunication terminal that has a cover like a flip rotatable with respect to the main body of the terminal, and the flip includes a microphone or covers the keyboard.

In this embodiment, a detection of opening/closing the terminal prompts a change of the waiting display; however, a detection of extending/shortening an extensible antenna can prompt changes of the waiting display.

The present invention is applicable to a foldable and portable telecommunication terminal that incorporates image pickup elements. Photos shot by the image pickup elements can be stored in data memory 31, and can be displayed on display section 4. The photos can be automatically changed following the opening/closing of the terminal as per the method discussed above.

What is claimed is:

1. A foldable and portable telecommunication terminal formed of two parts, the terminal comprising:
a memory for storing at least one picture data;
detecting means for detecting a movement between an open position and a closed position of the two parts; and
a display section for displaying the picture data,
wherein when the detecting means detects the movement between the closed position and the open position of the two parts, the display section displays a selected one of the plurality of picture data stored in the memory.

2. The foldable and portable telecommunication terminal of claim 1 further comprising an input section,
wherein the input section can select one picture data to be displayed on the display section out of the at least one picture data stored in the memory.

3. The foldable and portable telecommunication terminal of claim 1, wherein the display section displays the selected one picture data only in a standby mode.

4. A foldable and portable telecommunication terminal formed of two parts, the terminal comprising:
a first memory for storing at least one picture data;
detecting means for detecting a movement between an open position and a closed position of the two parts; and
a display section for displaying one of the picture data,
a second memory for storing information about at least one picture data selected by a user out of the at least one picture data stored in the first memory; and
a controller,
wherein when the detecting means detects the movement between the closed position and the open position of the two parts, the controller retrieves the picture data, corresponding to information selected out of the information stored in the second memory, from the first memory and displays the retrieved picture data on the display section.

5. The foldable and portable telecommunication terminal of claim 4, wherein the controller selects a piece of information at random out of the information stored in the second memory, and retrieves the picture data corresponding to the selected information from the first memory, and displays the retrieved picture data on the display section.

6. The foldable and portable telecommunication terminal of claim 4, wherein the controller selects information in a given sequence out of the information stored in the second memory, and retrieves the picture data corresponding to the selected information from the first memory, and displays the retrieved picture data on the display section.

7. The foldable and portable telecommunication terminal of claim 4 further comprising an input section which can select the given sequence of the information.

8. The foldable and portable telecommunication terminal of claim 4, wherein when the second memory stores only one piece of information about picture data, the controller displays the picture data corresponding to the one piece of information on the display section even if the detecting means detects the movement between the closed position and the open position.

9. The foldable and portable telecommunication terminal of claim 4, wherein when the second memory stores no information about the picture data, the controller displays a given data on the display section.

10. The foldable and portable telecommunication terminal of claim 4, wherein the controller detects a status of receiving an incoming call, and when the detecting means detects the movement between the closed position and the open position during the receiving status, the controller holds information selected from the second memory just before receiving the incoming call, and displays a given data on the display section.

11. The foldable and portable telecommunication terminal of claim 4, wherein the display section displays the selected picture data only in a standby mode.

12. The foldable and portable telecommunication terminal of claim 4,
wherein the controller selects information in a given sequence out of the information stored in the second memory, and retrieves the picture data, which corresponds to the selected information, from the first memory,
wherein when the detecting means detects a movement between the closed position and the open position during a receiving status, the controller holds the information selected from the second memory, and
wherein the display section displays the selected picture data only in a standby mode.

13. A method of controlling a foldable and portable telecommunication terminal formed of two parts and capable of displaying picture data, the method comprising the steps in the order of:
(a) detecting a movement of opening a folded two parts or closing the opened two parts;
(b) selecting one picture data out of at least one picture data stored in a memory; and
(c) displaying the selected picture data in a standby mode.

14. The method of claim 13, wherein when the movement of opening a folded two parts or closing the opened two parts is detected, the method further comprises the steps of:
(d) selecting a given one picture data; and
(e) setting an operation mode before step (d) for displaying the given picture data,
wherein a user can determine which one is used for changing the picture data, the automatic change or a manual change.

15. The method of claim 13 further comprising the steps of:
setting a display operation of a waiting display, wherein a user can determine which one is used for changing the picture data, the automatic change or a manual change;
confirming whether or not a set picture data is available, wherein the set picture data is assigned an automatic change; and
determining whether or not a plurality of the set picture data are available,
wherein whenever the movement of opening a folded two parts or closing the opened two parts is detected, the plurality of the set picture data are sequentially changed for displaying.
